(19) United States
(12) Patent Application Publication
(10) Pub. No.: US 2017/0250742 A1
(43) Pub. Date: Aug. 31, 2017

(54) COMMUNICATION DEVICE, COMMUNICATION METHOD, AND COMMUNICATION SYSTEM

(71) Applicant: FUJITSU LIMITED, Kawasaki-shi (JP)

(72) Inventor: Tsuyoshi HASEGAWA, Kawasaki (JP)

(21) Appl. No.: 15/440,923

(22) Filed: Feb. 23, 2017

(30) Foreign Application Priority Data
Feb. 29, 2016 (JP) 2016-037862

(51) Int. Cl. H04B 7/0456; H04B 7/0417

(52) U.S. Cl. CPC H04B 7/0456; H04B 7/0417

(57) ABSTRACT

A communication device including a memory and a processor coupled to the memory and the processor configured to specify eigenvalues of a solution matrix of a first equation, the first equation being base on a channel matrix representing a channel state between a first communication device and the communication device, the first communication device being a communication device different from a communication device of a transmission destination, the eigenvalues being specified by using a second equation about the eigenvalues, specify eigenvectors of the solution matrix based on the specified eigenvalues, generate weight information corresponding to a plurality of antennas based on the eigenvalues and the eigenvectors, and transmit a signal weighted based on the weight information to the communication device of the transmission destination by the plurality of antennas.

### CROSS-REFERENCE TO RELATED APPLICATION

This application is based upon and claims the benefit of priority of the prior Japanese Patent Application No. 2016-037862, filed on Feb. 29, 2016, the entire contents of which are incorporated herein by reference.

### FIELD

The present embodiments relate to a communication device, a communication method, and a communication system.

### BACKGROUND

There are mobile communication systems such as the third-generation mobile communication system (3G), LTE corresponding to the 3.9-generation mobile communication system, LTE-Advanced corresponding to the fourth-generation mobile communication system, and the fifth-generation mobile communication system (5G). LTE is an abbreviation of Long Term Evolution.

Furthermore, there is a frequency-space coding technique in which a symbol sequence to be input is pre-coded by utilizing a pre-coding weight matrix obtained by selecting a single weight matrix according to a given rule and the obtained symbol sequence is transmitted (for example, refer to Japanese National Publication of International Patent Application No. 2008-503150).

Moreover, there is Vandermonde-subspace frequency division multiplexing (VFDM) in which a signal is weighted by a Vandermonde matrix and radio transmission of the resulting signal is carried out. Furthermore, there is expanded VFDM in which a signal is weighted by a Vandermonde matrix in block unit and radio transmission of the resulting signal is carried out by plural transmitting antennas in order to avoid interference in a communication system using plural receiving antennas (for example, refer to Non-Patent Document: T. Hasegawa, “Efficient Multi-Antenna Expansion Method for Vandermonde-Subspace Frequency Division Multiplexing for 5G New Waveform,” PIMRC, Aug. 30, 2015).

### SUMMARY

According to an aspect of the embodiments, a communication device including a memory and a processor coupled to the memory and the processor configured to specify eigenvalues of a solution matrix of a first equation, the first equation being base on a channel matrix representing a channel state between a first communication device and the communication device, the first communication device being a communication device different from a communication device of a transmission destination, the eigenvalues being specified by using a second equation about the eigenvalues, specify eigenvectors of the solution matrix based on the specified eigenvalues, generate weight information corresponding to a plurality of antennas based on the eigenvalues and the eigenvectors, and transmit a signal weighted based on the weight information to the communication device of the transmission destination by the plurality of antennas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of a communication system according to embodiment 1;

FIG. 2 is a diagram illustrating one example of convergence of one component of solution matrix of a matrix according to embodiment 1;

FIG. 3 is a diagram illustrating one example of a weight matrix generating unit of a communication device according to embodiment 1;

FIG. 4 is a diagram illustrating one example of an eigenvalue calculating unit according to embodiment 1;

FIG. 5 is a flowchart illustrating one example of weight matrix operation processing by the communication device according to embodiment 1;

FIG. 6 is a diagram illustrating one example of the communication device according to embodiment 1;

FIG. 7 is a diagram illustrating one example of a hardware configuration of the communication device according to embodiment 1;

FIG. 8 is a diagram illustrating one example of a weight matrix generating unit of a communication device according to embodiment 2;

FIG. 9 is a flowchart illustrating one example of weight matrix operation processing by the communication device according to embodiment 2;

FIG. 10 is a diagram illustrating one example of a weight matrix generating unit of a communication device according to embodiment 3;

FIG. 11 is a diagram illustrating one example of transmission weights when grouping is carried out by the communication device according to embodiment 3; and

FIG. 12 is a diagram illustrating one example of a calculation result of eigenvalues by the communication device according to embodiment 3.

### DESCRIPTION OF EMBODIMENTS

However, in the above-described related art, a weight matrix of the expanded VFDM is generated by solving multivariable nonlinear simultaneous equations. Therefore, for example, when the number of transmitting antennas used in the expanded VFDM or the number of multipaths becomes large, the amount of operation for the weight matrix becomes large in some cases.

In one aspect, the embodiments intend to provide a communication device, a communication method, and a communication system that may reduce the amount of operation for a weight matrix used for radio transmission.

The embodiments of a communication device, a communication method, and a communication system will be described in detail below with reference to the drawings.

### Embodiment 1

(Communication System According to Embodiment 1)

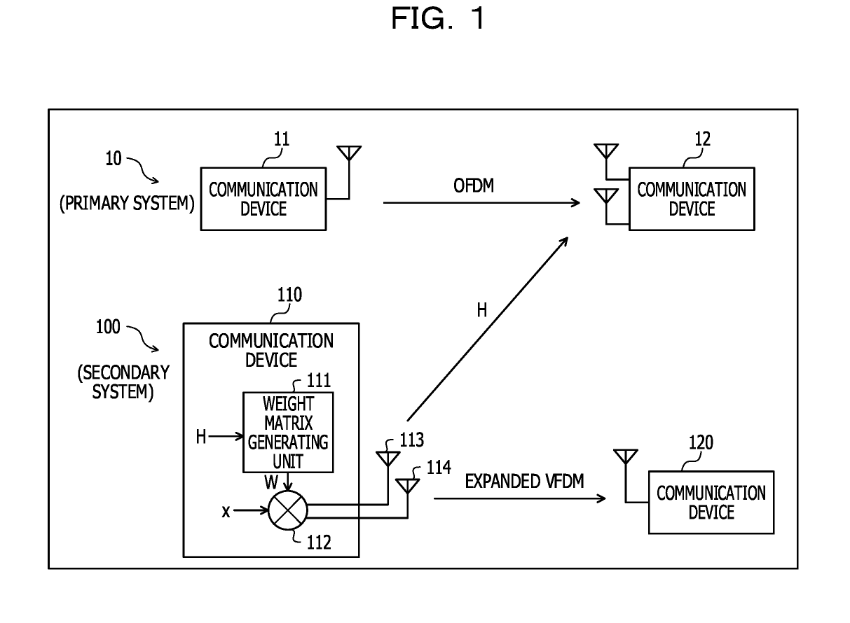

FIG. 1 is a diagram illustrating one example of a communication system according to embodiment 1. As illustrated in FIG. 1, a communication system 100 according to embodiment 1 is a secondary system that coexists with a communication system 10 that is a primary system. The communication system 10 includes communication devices 11 and 12. In the communication system 10, for example, radio transmission based on reception diversity with use of plural antennas at least on the receiving side is carried out from the communication device 11 to the communication device 12. For the radio transmission from the communication device 11 to the communication device 12, for example, orthogonal frequency division multiplexing (OFDM) or the like may be used.

The communication system 100 includes communication devices 110 and 120. In the communication system 100, for example, radio transmission based on expanded VFDM is carried out from the communication device 110 to the communication device 120 (transmission destination). The expanded VFDM is a system in which VFDM, in which a transmission signal is weighted by a Vandermonde matrix and radio transmission of the resulting signal is carried out, is expanded so as to be usable also when reception diversity with use of plural receiving antennas is implemented in the communication system 10. For example, the expanded VFDM is a system obtained by expanding the VFDM to multiple input multiple output (MIMO). For the expanded VFDM, OFDM or the like may be used, for example.

In the expanded VFDM, transmission antennas whose number is equal to or larger than the number of receiving antennas of the communication system 10 are used. In the example illustrated in FIG. 1, the number of receiving antennas of the communication system 10 is two and the number of transmitting antennas of the communication system 100 is also two. Due to this, a weight factor substantially orthogonal to a channel matrix H may be obtained also when reception diversity with use of plural receiving antennas is implemented in the communication system 10. The channel matrix H is a matrix representing the state of the channel from the communication device 110 to the communication device 12.

The communication device 110 includes, for example, a weight matrix generating unit 111, a multiplying unit 112, and antennas 113 and 114. The channel matrix H is input to the weight matrix generating unit 111. For example, the channel matrix H may be calculated in the communication device 110 based on a reception result in the communication device 110 regarding a radio signal from the communication device 12. Alternatively, the channel matrix H may be calculated in the communication device 12 based on a reception result in the communication device 12 regarding a radio signal from the communication device 110 and the calculated channel matrix H may be notified to the communication device 110.

The weight matrix generating unit 111 generates an expanded VFDM weight matrix W substantially orthogonal to the input channel matrix H and outputs the generated expanded VFDM weight matrix W to the multiplying unit 112. For example, the weight matrix generating unit 111 solves a second equation about eigenvalues of a solution matrix of a first equation based on the channel matrix H and thereby calculates the eigenvalues of the solution matrix of the first equation. The first equation is, for example, expression (4) to be described below. The second equation is, for example, expression (37) to be described below.

Then, the weight matrix generating unit 111 calculates eigenvectors of the solution matrix of the first equation based on the calculated eigenvalues. Next, the weight matrix generating unit 111 calculates the solution matrix of the first equation based on the calculated eigenvalues and eigenvectors of the solution matrix of the first equation. Then, the weight matrix generating unit 111 generates the expanded VFDM weight matrix W based on the calculated solution matrix.

The multiplying unit 112 and the antennas 113 and 114 are a transmitting unit that carries out radio transmission of a transmission signal x weighted by the expanded VFDM weight matrix W generated by the weight matrix generating unit 111 (generating unit) to the communication device 120 by the antennas 113 and 114. For example, the multiplying unit 112 carries out weighting of the transmission signal x by multiplying, from the left side, the transmission signal x to be transmitted to the communication device 120 by the expanded VFDM weight matrix W output from the weight matrix generating unit 111. Then, the multiplying unit 112 carries out radio transmission of the weighted transmission signal to the communication device 120 as a signal of expanded VFDM.

Based on the signal received from the communication device 110, the communication device 120 estimates a product H₀W of the expanded VFDM weight matrix W and a channel matrix H₀ representing the channel state between the communication device 110 and the communication device 120. Then, the communication device 120 reproduces the transmission signal x based on the estimated product H₀W.

The channel matrix H between the communication device 110 and the communication device 12 may be represented as the following expression (1), for example. In the following expression (1), A, B, and C are each a 2×2 matrix. For example, the channel matrix H may be represented by a matrix having A, B, and C, which are 2×2 matrices, as elements.

$$[ Expression 1 ]$$

$$\begin{matrix}H = ( \begin{matrix}c & f & b & e & a & d & 0 & 0 & 0 & 0 \\ i & l & h & k & g & j & 0 & 0 & 0 & 0 \\ 0 & 0 & c & f & b & e & a & d & 0 & 0 \\ 0 & 0 & i & l & h & k & g & j & 0 & 0 \\ 0 & 0 & 0 & 0 & c & f & b & e & a & d \\ 0 & 0 & 0 & 0 & i & l & h & k & g & j\end{matrix} ) \\ = ( \begin{matrix}C & B & A & 0 & 0 \\ 0 & C & B & A & 0 \\ 0 & 0 & C & B & A\end{matrix} )\end{matrix} \qquad ( 1 )$$

For this reason, if solutions S and T (are each a 2×2 matrix) of an equation about X (2×2 matrix) like the following expression (2) are obtained, a Vandermonde matrix having S⁰ to S⁴ and T⁰ to T⁴ based on S and T as elements is substantially orthogonal to the channel matrix H as represented in the following expression (3). However, because S and T are each a 2×2 matrix, the Vandermonde matrix is a Vandermonde matrix in block unit (expanded Vandermonde matrix). For example, the Vandermonde matrix is a block weight matrix obtained by arranging the respective weight matrices (A, B, C) of geometric progressions whose common ratios are the solution matrices (S, T) in order.

$$[ Expression 2 ]$$

$$\begin{matrix}C + BX + {AX}^{2} = 0 \\ [ Expression 3 ] & ( 2 ) \\ ( \begin{matrix}C & B & A & 0 & 0 \\ 0 & C & B & A & 0 \\ 0 & 0 & C & B & A\end{matrix} ) ( \begin{matrix}{S}^{0} & {T}^{0} \\ {S}^{1} & {T}^{1} \\ {S}^{2} & {T}^{2} \\ {S}^{3} & {T}^{3} \\ {S}^{4} & {T}^{4}\end{matrix} ) = 0 & ( 3 )\end{matrix}$$

Therefore, by carrying out weighting by multiplying the transmission signal x by the Vandermonde matrix in block unit on the left side and carrying out radio transmission in the communication device 110, radio transmission from the communication device 110 to the communication device 120 may be carried out without interference in the communication system 10.

The above-described expression (2) is an equation of a matrix polynomial of matrix coefficients (multivariable nonlinear simultaneous equations) and may be solved by an iterative solution method based on a Newton's method for a multivariable function, for example.

Here, as reference, the case of directly solving the matrix polynomial of matrix coefficients as the above-described expression (2) to obtain the solutions S and T of X will be described. The solutions of the matrix polynomial of the above-described expression (2) include a large number of solutions that are unnecessary (or redundant) for the weight calculation of the expanded VFDM. Thus, obtaining all solutions leads to much uselessness in terms of the amount of operation.

Therefore, for example, it is conceivable that eigenvalues are obtained from the solution matrix and are accumulated with the solution matrix in order to obtain necessary and sufficient solutions and a final weight matrix for the expanded VFDM is generated from the accumulated solution matrices at the timing when a sufficient number of eigenvalues are obtained (above-described Non-Patent Document). In this case, for example, a matrix polynomial of matrix coefficients like the following expression (4) is solved by the Newton's method.

$$[ Expression 4 ]$$

$$S ( Z ) = {\sum }_{i = 0}^{L} {C}_{i} {Z}^{L - i} = 0 \qquad ( 4 )$$

The above-described expression (4) is a polynomial of Z of an M×M matrix. M is the number of receiving antennas of the communication system 10 (=the number of transmitting antennas of the communication system 100). L is (the number of multipaths−1). The number of times of multiplication when the iterative operation of the Newton's method is performed one time based on the above-described expression (4) is 2LM³+L(L+3)M⁵/2+M⁶/3 times. From the fact that the order of M is particularly large, it turns out that the amount of operation increases as the number of receiving antennas of the communication system 10 (=the number of transmitting antennas of the communication system 100) becomes larger. As above, in the expanded VFDM of the related art, many operations are performed at the timing when the matrix polynomial of matrix coefficients is solved by the Newton's method although a certain level of efficient improvement may be achieved.

In contrast, the communication device 110 according to the embodiment reduces the amount of operation by transforming the simultaneous equations of the above-described expression (4) for obtaining a weight substantially orthogonal to the channel matrix H in the expanded VFDM into a polynomial of eigenvalues of the solution matrix of these simultaneous equations and obtaining the eigenvalues in advance. In this case, eigenvectors are obtained later. Therefore, the operation for the eigenvectors is added but the amount of operation is small compared with the calculation of the eigenvalues. Thus, the amount of operation may be reduced as the whole of the operation for obtaining the weight.

For example, the communication device 110 may be applied to a base station in a mobile communication system. In this case, the communication device 120 may be applied to a terminal, for example. However, the configuration is not limited to such a configuration. For example, the communication device 110 may be applied to a terminal and the communication device 120 may be applied to a base station.

Common formulas of the VFDM will be described. When the number of transmitting antennas of the secondary system is N_{TX} and the number of transmitting antennas of the primary system is N_{RX}, a similar argument holds if N_{TX}≧N_{RX} is satisfied. At this time, the channel matrix H representing the state of the channel from the communication device 110 (secondary system) to the communication device 12 (primary system) may be represented as the following expression (5), for example.

$$[ Expression 5 ]$$

$$( \begin{matrix}{C}_{L} & {C}_{L - 1} & … & {C}_{1} & {C}_{0} & 0 & 0 & 0 \\ 0 & {C}_{L} & {C}_{L - 1} & … & {C}_{1} & {C}_{0} & 0 & 0 \\ 0 & 0 & ⋱ & ⋱ & ⋱ & {C}_{1} & {C}_{0} & 0 \\ 0 & 0 & 0 & {C}_{L} & {C}_{L - 1} & … & {C}_{1} & {C}_{0}\end{matrix} ) \qquad ( 5 )$$

When N is defined as the number of received symbols per antenna (equivalent to the length of the OFDM symbol, for example), H is a matrix of NN_{RX} rows and (N+L−1)N_{TX} columns, and Cᵢ is a matrix of N_{RX} rows and N_{TX} columns and serves as a coefficient matrix of the expression for obtaining the orthogonal weight. Hereinafter, it is assumed that N_{RX}=N_{TX}=M is satisfied. The simultaneous equations for obtaining the orthogonal weight may be represented by the following expression (6), for example.

$$[ Expression 6 ]$$

$${\sum }_{i = 0}^{L} {C}_{i} {Z}^{L - i} = 0 \qquad ( 6 )$$

Here, Z is a matrix of N_{RX} rows and N_{TX} columns. Assuming that L solutions (A₁ to A_{L}) are found as solutions of Z, for example, in the above-described expression (6), each column of a matrix represented in the following expression (7) is the orthogonal weight, for example. For example, M×L orthogonal weights are obtained. As represented in the following expression (7), the expanded VFDM weight matrix W is a block matrix obtained by lining up the respective matrices of geometric progressions whose common ratios are the solution matrices (A₁ to A_{L}) of Z in order. Furthermore, because Z is a matrix of N_{RX} rows and N_{TX} columns, the expanded VFDM weight matrix W is a weight matrix having, as elements, matrices corresponding to the respective transmitting antennas of the communication device 110 and the respective receiving antennas of the communication device 12.

$$[ Expression 7 ]$$

$$W = ( \begin{matrix}{A}_{1}^{0} & {A}_{2}^{0} & … & {A}_{L}^{0} \\ {A}_{1}^{1} & {A}_{2}^{1} & … & {A}_{L}^{1} \\ ⋮ & ⋮ & ⋱ & ⋱ \\ {A}_{1}^{N + L - 1} & {A}_{2}^{N + L - 1} & 0 & {A}_{L}^{N + L - 1}\end{matrix} ) \qquad ( 7 )$$

Next, an implementation system of the Newton's method for the VFDM expanded to plural antennas will be described. First, a multivariable Newton's method will be described. In the Newton's method, nonlinear simultaneous equations desired to be solved are represented as the following expression (8), for example.

[Expression 8]

f(w)=0 (8)

Here, w is a multivariable column vector as represented by the following expression (9) (T is transposition symbol).

[Expression 9]

w=(w₁,w₂, . . . ,w_{K})^{T} (9)

Furthermore, f is a function vector that takes the vector w as an argument as represented by the following expression (10).

[Expression 10]

f(w)=(f₁(w),f₂(w), . . . ,f_{K}(w))^{T} (10)

In the multivariable Newton's method, w⁽⁰⁾ is used as the initial value of the vector w and, for example, iterative operation of the following expression (11) is performed to make convergence on a solution existing around the initial value.

[Expression 11]

w⁽ⁱ^{₀}⁺¹⁾=w⁽ⁱ^{₀}⁾−J(w⁽ⁱ^{₀}⁾)⁻¹f(w⁽ⁱ^{₀}⁾) (11)

Here, J is the Jacobian matrix and an element Jᵢⱼ of the Jacobian matrix J is obtained based on the following expression (12), for example.

$$\begin{matrix}[ Expression 12 ] & \\ {J}_{ij} ( w ) = \frac{\partial {f}_{i} ( w )}{\partial {w}_{j}} & ( 12 )\end{matrix}$$

For example, the derivative of f is obtained to use the Newton's method.

The above-described expression (4) is obtained by equalizing, to S(Z), the expression of the left side of the simultaneous equations of the above-described expression (6) for obtaining the orthogonal weight in the VFDM expanded to plural antennas.

In the above-described expression (4), Z is a matrix having unknowns as elements and an element Zᵢⱼ of the matrix Z corresponds to any of the elements of the vector of the above-described expression (9). Furthermore, Cᵢ is a coefficient matrix at each order. The function S(Z) includes powers of a matrix and therefore the derivative is not obtained based on a simple rule differently from the differentiation of powers of a scalar variable. For this reason, to directly obtain the derivative, differential operation is analytically carried out after the powers of the matrix are expanded, and the operation is highly-complicated operation particularly when a power of a high order for the VFDM exists. Therefore, an implementation system that makes the analytical differential operation unnecessary is desired.

In contrast, a system with which the analytical differential operation is reduced is used in the communication device 110 according to embodiment 1. First, assuming that elements of matrices A and B are functions of x, a consideration will be made about the differentiation of the product AB of these matrices. The differentiation of a component (AB)ᵢⱼ on the i-th row and the j-th column of AB may be, for example, represented as the following expression (13) with use of an element Aᵢₖ of the matrix A and so forth.

$$[ Expression 13 ]$$

$$\frac{\partial {( AB )}_{ij}}{\partial x} = \frac{\partial }{\partial x} ( {\sum }_{k = 1}^{N} {A}_{ik} {B}_{kj} ) = {\sum }_{k = 1}^{N} ( \frac{\partial {A}_{ik}}{\partial x} {B}_{kj} + {A}_{ik} \frac{\partial {B}_{kj}}{\partial x} ) \qquad ( 13 )$$

Thus, the differentiation of the product of matrices is represented as the following expression (14), for example. However, the differentiation of the matrix is the differentiation of each element of the matrix. Note that the order of the product is not variable here.

$$[ Expression 14 ]$$

$$\frac{\partial ( AB )}{\partial x} = \frac{\partial A}{\partial x} B + A \frac{\partial B}{\partial x} \qquad ( 14 )$$

When this rule is applied to the differentiation of the powers of Z in order, the differentiation of Z with respect to the variable x is represented as the following expression (15), for example.

$$\begin{matrix} [ Expression 15 ] & \\ \frac{\partial }{\partial x} {Z}^{i} = \frac{\partial }{\partial x} ( {Z}^{i - 1} Z ) = \frac{\partial {Z}^{i - 1}}{\partial x} Z + {Z}^{i - 1} \frac{\partial Z}{\partial x} = \frac{\partial {Z}^{i - 2}}{\partial x} {Z}^{2} + {Z}^{i - 2} \frac{\partial Z}{\partial x} Z + {Z}^{i - 1} \frac{\partial Z}{\partial x} = {\sum }_{j = 1}^{i} {Z}^{i - j} \frac{\partial Z}{\partial x} {Z}^{j - 1} & ( 15 )\end{matrix}$$

It turns out that, in the above-described expression (15), the differentiation of the powers of the matrix disappears and becomes the product of the differentiation of Z and Z. Operation included in the Newton's method is the differentiation of Z with respect to an element Z_{pq} and this may be easily obtained as represented by the following expression (16), for example.

$$[ Expression 16 ]$$

$${( \frac{\partial Z}{\partial {Z}_{pq}} )}_{ij} = \{ \begin{matrix}1 ( i = p and j = q ) \\ 0 ( i \neq p or j \neq q )\end{matrix} \qquad ( 16 )$$

For example, only the variable desired to be differentiated becomes 1 and the other variables become 0. For example, when a matrix as represented by the following expression (17) is differentiated with respect to s, the following expression (18) is obtained.

$$\begin{matrix}[ Expression 17 ] & \\ Z = ( \begin{matrix}s & t \\ u & v\end{matrix} ) & ( 17 ) \\ [ Expression 18 ] & \\ \frac{\partial Z}{\partial s} = ( \begin{matrix}1 & 0 \\ 0 & 0\end{matrix} ) & ( 18 )\end{matrix}$$

Thus, the differentiation of S with respect to an element Z_{pq} is represented by the following expression (19), for example.

$$[ Expression 19 ]$$

$$\frac{\partial S ( Z )}{\partial {Z}_{pq}} = {\sum }_{i = 0}^{L} {C}_{i} {\sum }_{j = 1}^{L - i} {Z}^{L - i - j} \frac{\partial Z}{\partial {Z}_{pq}} {Z}^{j - 1} = 0 \qquad ( 19 )$$

Here, the matrix resulting from the differentiation of Z is a matrix with only a constant as represented in the above-described expression (16), resulting in the fact that the derivative of S is obtained with only the product and sum of matrices.

Furthermore, the correspondence between w and Z and between f and S is decided in advance. For example, the configurations of matrices and vectors are different between the Newton's method and the expanded VFDM expanded to plural antennas, and therefore the correspondence of the configurations is made clear. For example, regarding subscript numbers, correspondences as represented by the following expression (20) and the following expression (21) are decided in advance.

[Expression 20]

k=(i−1)M+j (20)

[Expression 21]

l=(p−1)M+q (21)

Under this correspondence relationship, elements of x and X, elements of f and Y, and J and the derivative of Y are made to correspond as represented by the following expression (22), the following expression (23), and the following expression (24), for example.

$$\begin{matrix}[ Expression 22 ] & \\ {w}_{l} = {Z}_{pq} & ( 22 ) \\ [ Expression 23 ] & \\ {f}_{l} = {( S ( Z ) )}_{pq} & ( 23 ) \\ [ Expression 24 ] & \\ {J}_{kl} = {( \frac{\partial S ( z )}{\partial {Z}_{pq}} )}_{ij} & ( 24 )\end{matrix}$$

Due to this, conversion of w and f to Z and S and so forth may be properly carried out when a differential value is obtained based on the above-described expression (12) and when the above-described expression (11), which is an expression of the Newton's method, is applied.

Next, the relationship between the solution and the eigenvalue of the matrix Z of the above-described expression (4) will be described.

(Convergence of One Component of Solution Matrix of Matrix Z According to Embodiment 1)

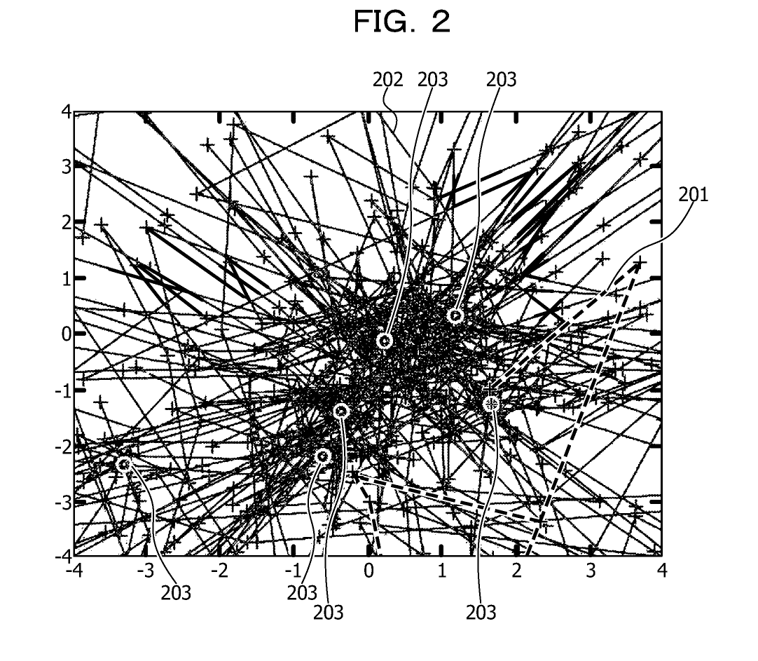

FIG. 2 is a diagram illustrating one example of convergence of one component of solution matrix of the matrix Z according to embodiment 1. In FIG. 2, the state of the convergence of one component of the solution matrix is represented on a complex plane. Furthermore, in FIG. 2, the case of obtaining the solutions under a condition of M=2 and L=2 will be described. A convergent sequence 201 is an example of a convergent sequence of the solution, indicated by a dotted line. Convergent sequences 202 are convergent sequences of the solutions that result from 100 kinds of initial value and are plotted by solid lines while being overlapped with each other. Convergent points 203 are six convergent points of one component of the matrix.

As illustrated in FIG. 2, when solutions are obtained with M=2 and L=2, six solutions are obtained, for example. In this case, two expanded VFDM weights are obtained with respect to one solution matrix and therefore twelve weights are obtained in total. However, the number of independent weights among these weights is four. This will be because L independent weights are obtained with respect to the highest order L when the number of antennas is one and thus double weights are obtained due to flexibility obtained by doubling of the number of antennas.

Next, the reason why the number of solutions is six will be described. When the eigenvalues of the obtained solutions were examined, it turned out that only four kinds of eigenvalues existed with respect to the six solutions. From this, the following thought may be made. For example, each solution may be represented as the following expression (25) with use of an eigenvalue λᵢ and an eigenvector vᵢ.

$$[ Expression 25 ]$$

$$Z = ( {v}_{i} {v}_{j} ) ( \begin{matrix}{λ}_{i} & 0 \\ 0 & {λ}_{j}\end{matrix} ) {( {v}_{i} {v}_{j} )}^{- 1} \qquad ( 25 )$$

For example, the solution of the above-described expression (6) may be configured by selecting two eigenvalues from the four eigenvalues and thus the number of solutions is ₄C₂=6. When it is assumed that N_{TX}=N_{RX}=M is satisfied and the highest order is L, the number of independent expanded VFDM weights is ML and the number of solutions of the matrix polynomial is _{ML}C_{M}.

Here, the fact that the order of the eigenvalue is irrelevant from the definition of the eigenvalue may be represented as the following expression (26) and the following expression (27), for example.

[Expression 26]

Zvᵢ=λᵢvᵢ (26)

[Expression 27]

Zvⱼ=λⱼvⱼ (27)

When these are lined up side by side, the following expression (28) and the following expression (29) are obtained and the above-described expression (25) may be derived.

$$\begin{matrix}[ Expression 28 ] & \\ ( \begin{matrix}{Zv}_{i} & {Zv}_{j}\end{matrix} ) = ( \begin{matrix}{λ}_{i} {v}_{i} & {λ}_{j} {v}_{j}\end{matrix} ) & ( 28 ) \\ [ Expression 29 ] & \\ \begin{matrix}Z ( {v}_{i} & {v}_{j}\end{matrix} ) = ( \begin{matrix}{v}_{i} & {v}_{j}\end{matrix} ) ( \begin{matrix}{λ}_{i} & 0 \\ 0 & {λ}_{j}\end{matrix} ) & ( 29 )\end{matrix}$$

Furthermore, for example, when these are inversely lined up as represented by the following expression (30) and the following expression (31), an expression in which i and j are inverted is obtained and it turns out that the solution is irrelevant to the order of i and j.

$$\begin{matrix}[ Expression 30 ] & \\ ( \begin{matrix}{Zv}_{j} & {Zv}_{i}\end{matrix} ) = ( \begin{matrix}{λ}_{j} {v}_{j} & {λ}_{i} {v}_{i}\end{matrix} ) & ( 30 ) \\ [ Expression 31 ] & \\ \begin{matrix}Z ( {v}_{j} & {v}_{i}\end{matrix} ) = ( \begin{matrix}{v}_{j} & {v}_{i}\end{matrix} ) ( \begin{matrix}{λ}_{j} & 0 \\ 0 & {λ}_{i}\end{matrix} ) & ( 31 )\end{matrix}$$

Therefore, to obtain the weights without excess and deficiency, after eigenvalues and eigenvectors are obtained regarding solutions obtained by the Newton's method and ML solutions are obtained without overlapping, solutions are reconfigured based on the above-described expression (25) and the weights are obtained based on powers of the solutions.

Next, a method for obtaining the eigenvalues earlier than the solutions will be described. When the solution matrix is diagonalized with the eigenvalues, the following expression (32) is obtained, for example.

$$[ Expression 32 ]$$

$$Z = ( \begin{matrix}{v}_{1} & {v}_{2} & …\end{matrix} ) ( \begin{matrix}{λ}_{1} & 0 & 0 & … \\ 0 & {λ}_{2} & & \\ ⋮ & & & ⋱\end{matrix} ) {( \begin{matrix}{v}_{1} & {v}_{2} & …\end{matrix} )}^{- 1} = V Λ {V}^{- 1} \qquad ( 32 )$$

When the Z is substituted into the above-described expression (6), the following expression (33) is obtained.

[Expression 33]

Σᵢ₌₀^{L}CᵢVΛ^{L-i}=0 (33)

Although the number of unknowns is one, for example, Z, in the above-described expression (6), the number of unknowns is two, for example, V and Λ, in the above-described expression (33). For this reason, it is difficult to simply solve the above-described expression (33). Therefore, first the above-described expression (33) is transformed to the following expression (34).

$$[ Expression 34 ]$$

$$\begin{matrix}{\sum }_{i = 0}^{L} {C}_{i} V {Λ}^{L - i} = {\sum }_{i = 0}^{L} {C}_{i} ( \begin{matrix}{v}_{1} & {v}_{2} & …\end{matrix} ) {( \begin{matrix}{λ}_{1} & 0 & 0 & … \\ 0 & {λ}_{2} & & \\ ⋮ & & & ⋱\end{matrix} )}^{L - i} \\ = {\sum }_{i = 0}^{L} {C}_{i} ( \begin{matrix}{λ}_{1}^{L - i} {v}_{1} & {λ}_{1}^{L - i} {v}_{2} & …\end{matrix} ) = 0\end{matrix} \qquad ( 34 )$$

Then, when a certain column is extracted from the above-described expression (34), the equation may be represented as the following expression (35) and the following expression (36), for example. Note that the subscripts of the eigenvalue and the eigenvector are omitted for simplification.

[Expression 35]

Σᵢ₌₀^{L}λ^{L-i}Cᵢv=0 (35)

[Expression 36]

(Σᵢ₌₀^{L}λ^{L-i}Cᵢ)v=0 (36)

Here, v is the eigenvector and is not 0. For this reason, the condition with which the above-described expression (35) and the above-described expression (36) hold is represented as the following expression (37), for example.

[Expression 37]

det(Σᵢ₌₀^{L}λ^{L-i}Cᵢ)=0 (37)

The above-described expression (37) is an ML-order equation about λ (eigenvalue). Furthermore, although the order increases, expression (37) is an equation of a scalar variable and thus may be solved by using various solution methods. After λ is obtained, obtained λ is substituted into the parentheses of the above-described expression (36) to obtain a matrix, and a vector substantially orthogonal to the row vector in the obtained matrix is obtained.

It is not easy to expand the above-described expression (37) and obtain the coefficient of each order. Thus, it is also conceivable that the above-described expression (37) is solved by the Newton's method without the expansion. At this time, the differentiation of the above-described expression (37) is performed. The differentiation of det(X) is obtained based on the following expression (38), for example.

[Expression 38]

d(det(X))=det(X)(X^{-T}):^{T}dX: (38)

In this regard, however, X: is a vector obtained by vertically lining up all elements of a matrix X. For example, X:^{T}Y: is what is obtained by multiplying and adding all corresponding elements of X and Y. In the case of using Matlab or Octave as a numerical value operation tool, X:^{T}Y: may be described as sum(sum(X.*Y)), for example.

When the eigenvalues (λ₁ to λ_{L}) and the eigenvectors (v₁ to v_{L}) are obtained in the above-described manner, it turns out that the expanded VFDM weight matrix W of the following expression (39) is substantially orthogonal to the channel matrix H from the relationship of the above-described expression (35). In this format, a power of a matrix does not appear and thus the weights may be obtained more easily than with the above-described expression (7). The expanded VFDM weight matrix W of the following expression (39) is a weight matrix having, as elements, matrices of N_{RX} rows and N_{TX} columns corresponding to the respective transmitting antennas of the communication device 110 and the respective receiving antennas of the communication device 12.

$$[ Expression 39 ]$$

$$W = ( \begin{matrix}{λ}_{1}^{0} {v}_{1} & {λ}_{2}^{0} {v}_{2} & … & {λ}_{L}^{0} {v}_{L} \\ {λ}_{1}^{1} {v}_{1} & {λ}_{2}^{1} {v}_{2} & … & {λ}_{L}^{1} {v}_{L} \\ ⋮ & ⋮ & ⋱ & ⋱ \\ {λ}_{1}^{N + L - 1} {v}_{1} & {λ}_{2}^{N + L - 1} {v}_{2} & 0 & {λ}_{L}^{N + L - 1} {v}_{L}\end{matrix} ) \qquad ( 39 )$$

As above, the communication device 110, for example, does not directly solve the equation of the matrix polynomial of matrix coefficients based on the above-described expression (4) but obtains eigenvalues by using operation transformed to an equation of the eigenvalues of the solution matrix like the above-described expression (37). Due to this, the number of operations for solving the equation is greatly reduced and the expanded VFDM weight matrix W is efficiently obtained.

For example, the number of times of multiplication when the iterative operation of the Newton's method is performed one time based on the above-described expression (37) is 2LM²+M(M²+1)+(L−1)(1+M²)+4M³/3+M²+1 times. Therefore, because the orders of M are equal to or lower than three and the order of L is also equal to or lower than one, increase in the amount of operation is suppressed even when the number of receiving antennas of the communication system 10 (=the number of transmitting antennas of the communication system 100) becomes larger.

As one example, for example, if the number of times of multiplication when the number of antennas=2 (M=2) and the number of multipaths=11 (L=10) is calculated, the multiplication in the case of solving the above-described expression (4) is approximately 2275 times, and the multiplication in the case of solving the above-described expression (37) is approximately 111 times, which is approximately 1/20 as the number of times of multiplication. However, in the communication device 110 according to embodiment 1, the eigenvectors are obtained from the eigenvalues and the solution matrix is further obtained in order to obtain the expanded VFDM weight matrix W, and thus the amount of operation for this purpose is approximately M³. However, this operation is only one time of operation after the iterative operation of the Newton's method and therefore the influence on the amount of overall operation is small.

Next, an actual calculation example in embodiment 1 will be described. For example, assuming that L=1 and M=2 in the above-described expression (5), the channel matrix H is represented as the following expression (40), for example.

$$[ Expression 40 ]$$

$$H = ( \begin{matrix}{C}_{1} & {C}_{0} & 0 \\ 0 & {C}_{1} & {C}_{0}\end{matrix} ) \qquad ( 40 )$$

At this time, eigenvalues are obtained by using C₁ and C₀. As one example, C₀ and C₁ are defined as represented by the following expression (41) and the following expression (42).

$$\begin{matrix}[ Expression 41 ] & \\ {C}_{0} = ( \begin{matrix}4 & 3 \\ 8 & 7\end{matrix} ) & ( 41 ) \\ [ Expression 42 ] & \\ {C}_{1} = ( \begin{matrix}2 & - 1 \\ 6 & 5\end{matrix} ) & ( 42 )\end{matrix}$$

The channel matrix H at this time is represented as the following expression (43).

$$\begin{matrix}[ Expression 43 ] & \\ H = ( \begin{matrix}2 & - 1 & 4 & 3 & 0 & 0 \\ 6 & 5 & 8 & 7 & 0 & 0 \\ 0 & 0 & 2 & - 1 & 4 & 3 \\ 0 & 0 & 6 & 5 & 8 & 7\end{matrix} ) & ( 43 )\end{matrix}$$

The eigenvalues are obtained under this condition. In this case, because LM=2, it is expected that two eigenvalues are obtained. To obtain the eigenvalues, the above-described expression (37) is used. For example, operation is performed as represented in the following expression (44) to the following expression (48).

$$\begin{matrix}[ Expression 44 ] & \\ det ( {\sum }_{i = 0}^{1} {λ}^{1 - i} {C}_{i} ) = 0 & ( 44 ) \\ [ Expression 45 ] & \\ det ( λ ( \begin{matrix}4 & 3 \\ 8 & 7\end{matrix} ) + ( \begin{matrix}2 & - 1 \\ 6 & 5\end{matrix} ) ) = 0 & ( 45 ) \\ [ Expression 46 ] & \\ det ( ( \begin{matrix}4 λ + 2 & 3 λ - 1 \\ 8 λ + 6 & 7 λ + 5\end{matrix} ) ) = 0 & ( 46 ) \\ [ Expression 47 ] & \\ ( 4 λ + 2 ) ( 7 λ + 5 ) - ( 3 λ - 1 ) ( 8 λ + 6 ) = 0 & ( 47 ) \\ [ Expression 48 ] & \\ {λ}^{2} + 2 λ + 4 = 0 & ( 48 )\end{matrix}$$

When the equation of the above-described expression (48) is solved, two eigenvalues λ₁ and λ₂ represented in the following expression (49) are obtained as solutions.

[Expression 49]

λ₁=−3+\sqrt{5}, λ₂=−3−\sqrt{5} (49)

In this example, the above-described expression (37) is easily solved. However, in the commonly case, solutions are numerically obtained by using the Newton's method or the like and the result is also complex numbers.

Next, eigenvectors are obtained. The eigenvectors are vectors substantially orthogonal to the matrix in the above-described expression (46), for example, a matrix of the following expression (50).

$$\begin{matrix}[ Expression 50 ] & \\ ( \begin{matrix}4 λ + 2 & 3 λ - 1 \\ 8 λ + 6 & 7 λ + 5\end{matrix} ) & ( 50 )\end{matrix}$$

When λ₁ is substituted into the above-described expression (50), the matrix is represented as the following expression (51).

$$\begin{matrix}[ Expression 51 ] & \\ ( \begin{matrix}- 10 + 4 \sqrt{5} & - 10 + 3 \sqrt{5} \\ - 18 + 8 \sqrt{5} & - 16 + 7 \sqrt{5}\end{matrix} ) & ( 51 )\end{matrix}$$

The eigenvector may be obtained by obtaining a vector orthogonal to the matrix represented in the above-described expression (51). As an easy method for obtaining the orthogonal vector, only the lowermost row of the matrix is changed to certain values and thereafter a matrix resulting from the Hermitian transposition of the changed matrix is subjected to QR decomposition. Then, the column vector on the rightmost column of the matrix Q is acquired. The QR decomposition is processing of decomposing an m×n real matrix A into the product of an m-order orthogonal matrix Q and an m×n upper triangular matrix R. For example, the lowermost row of the matrix represented in the above-described expression (51) is changed to (1, 0) to make a matrix represented in the following expression (52).

$$\begin{matrix}[ Expression 52 ] & \\ ( \begin{matrix}- 10 + 4 \sqrt{5} & - 10 + 3 \sqrt{5} \\ 1 & 0\end{matrix} ) & ( 52 )\end{matrix}$$

Next, when the matrix represented in the above-described expression (52) is Hermitian-transposed, the resulting matrix is represented as the following expression (53). In this case, the Hermitian transposition is mere transposition because the matrix is a real number matrix.

$$\begin{matrix}[ Expression 53 ] & \\ ( \begin{matrix}- 10 + 4 \sqrt{5} & 1 \\ - 10 + 3 \sqrt{5} & 0\end{matrix} ) & ( 53 )\end{matrix}$$

When the matrix represented in the above-described expression (53) is subjected to QR decomposition, a matrix Q of the following expression (54) is obtained through numerical value operation.

$$\begin{matrix}[ Expression 54 ] & \\ ( \begin{matrix}- 0.3053931877 & - 0.9522263391 \\ - 0.9522263391 & - 0.30539391877\end{matrix} ) & ( 54 )\end{matrix}$$

The column vector at the rightmost end of the matrix Q of the above-described expression (54) is the eigenvector v₁ as represented in the following expression (55).

$$\begin{matrix}[ Expression 55 ] & \\ {v}_{1} = ( \begin{matrix}- 0.9522263391 \\ 0.3053931877\end{matrix} ) & ( 55 )\end{matrix}$$

It may be confirmed that, when the eigenvector v₁ of the above-described expression (55) is multiplied by the matrix of the above-described expression (51), the calculation result is almost 0. Similarly, the eigenvector v₂ corresponding to the other eigenvalue λ₂ is also obtained as represented in the following expression (56).

$$\begin{matrix}[ Expression 56 ] & \\ {v}_{2} = ( \begin{matrix}- 0.6614584599 \\ 0.7499818037\end{matrix} ) & ( 56 )\end{matrix}$$

Next, when the solution of the solution matrix Z is obtained by using the above-described expression (32) and the eigenvalues λ₁ and λ₂ and the eigenvectors v₁ and v₂, the solution is represented as the following expression (57).

$$\begin{matrix}[ Expression 57 ] & \\ Z = ( \begin{matrix}{v}_{1} & {v}_{2}\end{matrix} ) ( \begin{matrix}{λ}_{1} & 0 \\ 0 & {λ}_{2}\end{matrix} ) {( \begin{matrix}{v}_{1} & {v}_{2}\end{matrix} )}^{- 1} = ( \begin{matrix}1 & 5.5 \\ - 2 & - 7\end{matrix} ) & ( 57 )\end{matrix}$$

Furthermore, when the expanded VFDM weight matrix W is obtained by using the above-described expression (7) and the solution of the solution matrix Z, the expanded VFDM weight matrix W is represented as the following expression (58). The number of solution matrices in this case is one.

$$\begin{matrix}[ Expression 58 ] & \\ W = ( \begin{matrix}{Z}^{0} \\ {Z}^{1} \\ {Z}^{2}\end{matrix} ) = ( \begin{matrix}1 & 0 \\ 0 & 1 \\ 1 & 5.5 \\ - 2 & - 7 \\ - 10 & - 33 \\ - 12 & 38\end{matrix} ) & ( 58 )\end{matrix}$$

When the product HW of the channel matrix H of the above-described expression (43) and the expanded VFDM weight matrix W of the above-described expression (58) is calculated, it turns out that the product HW is 0. Therefore, by multiplying the transmission signal x by the expanded VFDM weight matrix W of the above-described expression (58) on the left side and carrying out radio transmission, the communication device 110 may carry out radio transmission to the communication device 120 without interference in the communication system 10.

(Weight Matrix Generating Unit of Communication Device According to Embodiment 1)

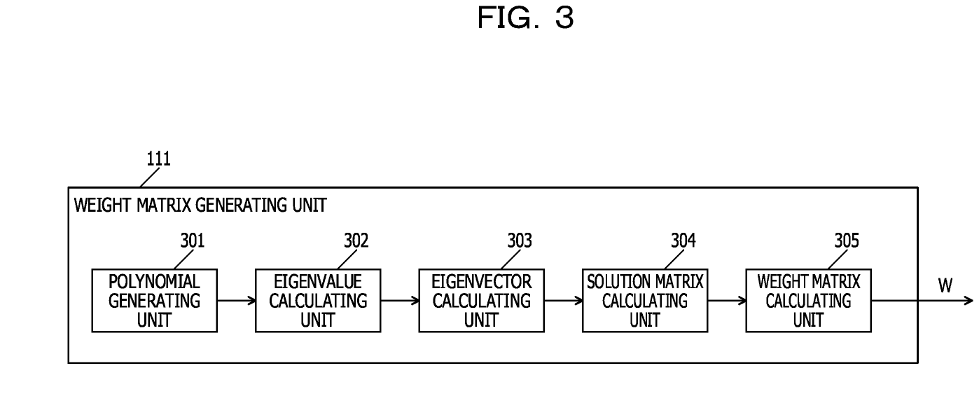

FIG. 3 is a diagram illustrating one example of a weight matrix generating unit of a communication device according to embodiment 1. As illustrated in FIG. 3, the weight matrix generating unit 111 of the communication device 110 according to embodiment 1 includes, for example, a polynomial generating unit 301, an eigenvalue calculating unit 302, an eigenvector calculating unit 303, a solution matrix calculating unit 304, and a weight matrix calculating unit 305.

The polynomial generating unit 301 generates a polynomial based on the above-described expression (37) based on M (the number of antennas) and L+1 (the number of multipaths). The polynomial based on the above-described expression (37) is a polynomial whose solutions are the eigenvalues λ of the solution matrix of the matrix Z of the above-described expression (4). The polynomial generating unit 301 notifies the eigenvalue calculating unit 302 of the generated polynomial.

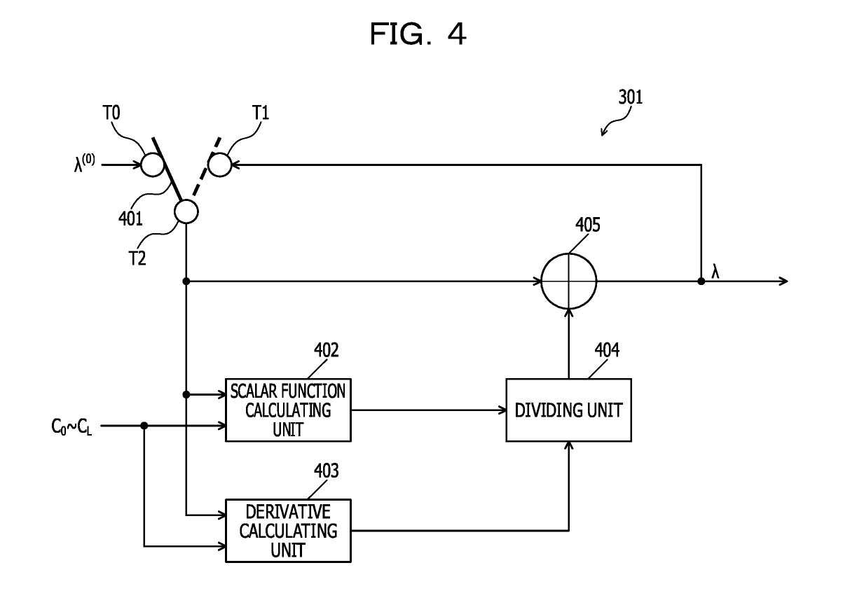

The eigenvalue calculating unit 302 obtains the solutions (eigenvalues λ) of the above-described expression (37) by solving the polynomial notified from the polynomial generating unit 301 by iterative operation of the Newton's method. As the initial value (eigenvalue λ) in the iterative operation of the Newton's method, a random initial value λ⁽⁰⁾ may be used, for example. Furthermore, the eigenvalue calculating unit 302 repeats the operation of solving the polynomial until ML different solutions (eigenvalues λ) are obtained. Then, the eigenvalue calculating unit 302 notifies the eigenvector calculating unit 303 of the obtained ML eigenvalues λ. The calculation of the eigenvalues λ in the eigenvalue calculating unit 302 will be described later (for example, see FIG. 4).

The eigenvector calculating unit 303 calculates the eigenvectors v each corresponding to a respective one of the ML eigenvalues λ notified from the eigenvalue calculating unit 302. For example, the eigenvector calculating unit 303 substitutes the eigenvalue λ into the parentheses of the above-described expression (36) to obtain a matrix, and obtains a vector orthogonal to a row vector in the obtained matrix. Thereby, the eigenvector calculating unit 303 may calculate the eigenvector v corresponding to the eigenvalue λ. The eigenvector calculating unit 303 notifies the solution matrix calculating unit 304 of the ML eigenvalues λ notified from the eigenvalue calculating unit 302 and the eigenvectors v calculated regarding each of the ML eigenvalues λ.

The solution matrix calculating unit 304 calculates the solutions (A₁ to A_{L}) of Z based on the ML eigenvalues λ and the ML eigenvectors v notified from the eigenvector calculating unit 303 and the above-described expression (32). Then, the solution matrix calculating unit 304 notifies the weight matrix calculating unit 305 of the calculated solutions (A₁ to A_{L}) of Z.

The weight matrix calculating unit 305 calculates the expanded VFDM weight matrix W based on the solutions (A₁ to A_{L}) of Z notified from the solution matrix calculating unit 304 and the above-described expression (7). Then, the weight matrix calculating unit 305 outputs the calculated expanded VFDM weight matrix W to the multiplying unit 112 (see FIG. 1). This may generate the expanded VFDM weight matrix W substantially orthogonal to the channel matrix H and output the expanded VFDM weight matrix W to the multiplying unit 112.

(Eigenvalue Calculating Unit According to Embodiment 1)

FIG. 4 is a diagram illustrating one example of an eigenvalue calculating unit according to embodiment 1. If the eigenvalue calculating unit 302 illustrated in FIG. 3 calculates the solutions of λ of the above-described expression (37) by iterative operation of the Newton's method, the eigenvalue calculating unit 302 may employ a configuration illustrated in FIG. 4, for example. The eigenvalue calculating unit 302 illustrated in FIG. 4 includes a switch 401, a scalar function calculating unit 402, a derivative calculating unit 403, a dividing unit 404, and a subtracting unit 405.

The switch 401 couples either an input part T0 or T1 to an output part T2. To the input part T0, the random eigenvalue λ⁽⁰⁾ for use as the initial value is input. To the input part T1, the eigenvalue λ output from the subtracting unit 405 is input. The eigenvalue λ⁽⁰⁾ and the eigenvalue λ are both a scalar value. The switch 401 couples the input part T0 to the output part T2 in the first round of operation of the Newton's method and couples the input part T1 to the output part T2 in the second and subsequent rounds of operation of the Newton's method. The eigenvalue λ output from the switch 401 is output to the scalar function calculating unit 402, the derivative calculating unit 403, and the subtracting unit 405.

To each of the scalar function calculating unit 402 and the derivative calculating unit 403, the eigenvalue output from the switch 401 and C₀ to C_{L} are input. C₀ to C_{L} are elements of the channel matrix H input to the weight matrix generating unit 111 (for example, see FIG. 1) as represented in the above-described expression (5).

The scalar function calculating unit 402 calculates the left side of the above-described expression (37) based on the eigenvalue λ output from the switch 401 and input C₀ to C_{L}. Because the eigenvalue λ and C₀ to C_{L} are scalar values, the calculation by the scalar function calculating unit 402 is operation of a scalar function. The scalar function calculating unit 402 outputs the calculated value to the dividing unit 404.

The derivative calculating unit 403 calculates a derivative obtained by differentiating the left side of the above-described expression (37) with respect to λ based on the eigenvalue λ output from the switch 401 and input C₀ to C_{L}. For example, the derivative calculating unit 403 may calculate the derivative by using the above-described expression (38). The derivative calculating unit 403 outputs the calculated derivative to the dividing unit 404.

Operation corresponding to the above-described expression (11) is performed by the dividing unit 404 and the subtracting unit 405. For example, the dividing unit 404 divides the value output from the scalar function calculating unit 402, for example, the left side of the above-described expression (37), by the value output from the derivative calculating unit 403, for example, the derivative of the left side of the above-described expression (37). Because the respective values output from the scalar function calculating unit 402 and the derivative calculating unit 403 are scalar values, the operation by the dividing unit 404 is operation of the scalar values. The dividing unit 404 outputs the value obtained by the division to the subtracting unit 405.

The subtracting unit 405 subtracts the value output from the dividing unit 404 from the eigenvalue λ output from the switch 401. Then, the subtracting unit 405 outputs the value obtained by the subtraction as a new eigenvalue λ. The eigenvalue λ output from the subtracting unit 405 is output to the eigenvector calculating unit 303 (for example, see FIG. 3) and is fed back to the input part T1 of the switch 401.

As above, the configuration is employed in which the eigenvalues λ of the solution matrix of the matrix Z are calculated by using the above-described expression (37) through iterative operation of the Newton's method before the solution matrix of the matrix Z is obtained. This allows, for example, the operation in the scalar function calculating unit 402, the derivative calculating unit 403, and the solution matrix calculating unit 304 to be operation of scalar values, which may reduce the amount of operation compared with the case of solving the solution matrix of the matrix Z by the Newton's method, for example.

(Weight Matrix Operation Processing by Communication Device According to Embodiment 1)

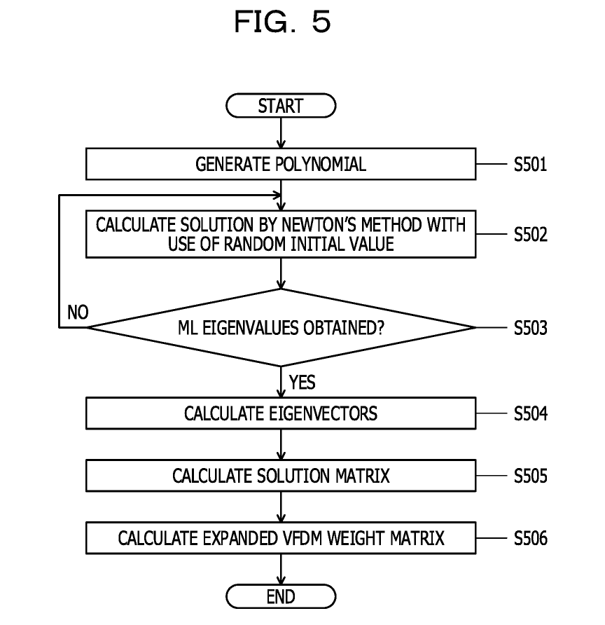

FIG. 5 is a flowchart illustrating one example of weight matrix operation processing by the communication device according to embodiment 1. The communication device 110 according to embodiment 1, for example, carries out each step depicted in FIG. 5 as operation processing of the expanded VFDM weight matrix W. First, the communication device 110 generates a polynomial of the eigenvalue λ of the solution matrix of the matrix Z based on M (the number of antennas) and L+1 (the number of multipaths) (step S501). The polynomial of the eigenvalue λ of the solution matrix of the matrix Z is a polynomial based on the above-described expression (37), for example.

Next, the communication device 110 calculates one solution of the polynomial generated by the step S501 by the Newton's method with use of the random initial value λ⁽⁰⁾ of the eigenvalue λ (step S502). The solution obtained by the step S502 is the eigenvalue λ. Furthermore, the operation by the step S502 is iterative operation in the configuration illustrated in FIG. 4, for example.

Next, the communication device 110 determines whether or not ML different eigenvalues λ have been obtained as the result of the calculation of the solution (eigenvalue λ) by the step S502 (step S503). If the ML different eigenvalues λ have not yet been obtained (step S503: No), the communication device 110 returns to the step S502.

If the ML different eigenvalues λ have been obtained in the step S503 (step S503: Yes), the communication device 110 calculates an eigenvector about each of the ML different eigenvalues λ obtained by the step S502 (step S504). The calculation of the eigenvector in the step S504 may be carried out by substituting the eigenvalue λ into the parentheses of the above-described expression (36) to obtain a matrix and obtaining a vector orthogonal to a row vector in the obtained matrix, for example.

Next, the communication device 110 calculates the solution matrix based on the ML eigenvalues calculated by the steps S502 and S503 and the ML eigenvectors calculated by the step S504 (step S505). The calculation of the solution matrix in the step S505 may be carried out based on the above-described expression (32), for example.

Next, the communication device 110 calculates the expanded VFDM weight matrix W based on the solution matrix generated by the step S505 (step S506) and ends the series of weight matrix operation processing. The generation of the expanded VFDM weight matrix W by the step S506 may be carried out based on the above-described expression (7), for example.

By the respective steps depicted in FIG. 5, the communication device 110 may generate the expanded VFDM weight matrix W substantially orthogonal to the channel matrix H. For example, the communication device 110 periodically acquires the channel matrix H and carries out each step depicted in FIG. 5 every time the new channel matrix H is acquired. Due to this, even when the propagation environment between the communication device 110 and the communication device 12 changes and the channel matrix H changes, the expanded VFDM weight matrix W with which interference with the communication system 10 is avoided may be generated.

(Communication Device According to Embodiment 1)

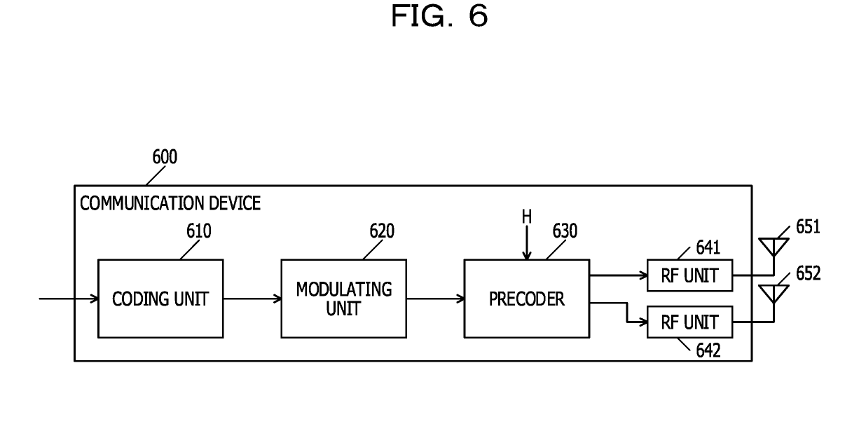

FIG. 6 is a diagram illustrating one example of the communication device according to embodiment 1. The communication device 110 illustrated in FIG. 1 may be implemented by a communication device 600 illustrated in FIG. 6, for example. The communication device 600 includes a coding unit 610, a modulating unit 620, a precoder 630, radio frequency (RF) units 641 and 642, and antennas 651 and 652. The coding unit 610 codes data to be transmitted to the communication device 120 (for example, user data and control information). Then, the coding unit 610 outputs the coded data to the modulating unit 620.

The modulating unit 620 carries out modulation based on the data output from the coding unit 610. For the modulation by the modulating unit 620, various kinds of modulation systems such as quadrature phase shift keying (QPSK) and 16 quadrature amplitude modulation (QAM) may be used. The modulating unit 620 outputs a signal obtained by the modulation to the precoder 630 as the transmission signal x illustrated in FIG. 1.

The precoder 630 carries out precoding for the transmission signal x output from the modulating unit 620. The weight matrix generating unit 111 and the multiplying unit 112 illustrated in FIG. 1 may be implemented by the precoder 630, for example. The precoder 630 carries out weighting by the expanded VFDM weight matrix W based on the channel matrix H on the transmission signal x output from the modulating unit 620, and outputs the respective weighted transmission signals to the RF units 641 and 642.

Each of the RF units 641 and 642 executes RF transmission processing of the transmission signal output from the precoder 630. In the RF transmission processing by the RF units 641 and 642, conversion from a digital signal to an analog signal, frequency conversion from the baseband to an RF (high-frequency) band, amplification, and so forth are included, for example. The RF units 641 and 642 output the signal resulting from the RF transmission processing to the antennas 651 and 652, respectively. The antennas 651 and 652 carry out radio transmission of the transmission signal output from the RF units 641 and 642, respectively, to the communication device 120.

The weight matrix generating unit 111 and the multiplying unit 112 illustrated in FIG. 1 may be implemented by the precoder 630, for example. The antennas 113 and 114 illustrated in FIG. 1 may be implemented by the antennas 651 and 652, for example. Although the configuration in which the communication device 600 includes two transmitting antennas (antennas 651 and 652) is described in the example illustrated in FIG. 6, the communication device 600 may include three or more transmitting antennas.

(Hardware Configuration of Communication Device According to Embodiment 1)

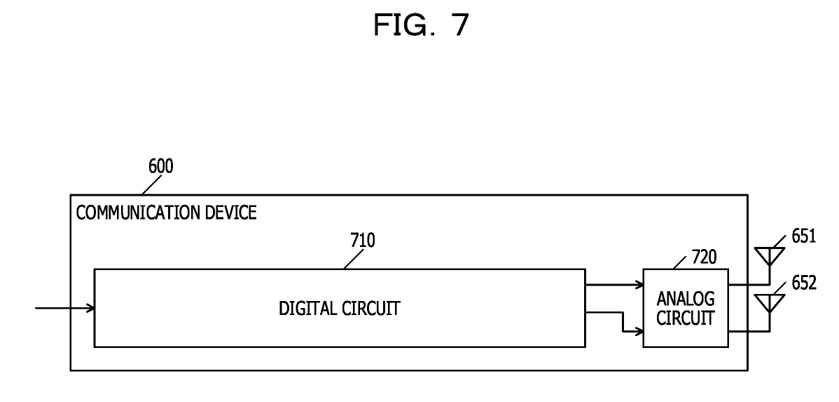

FIG. 7 is a diagram illustrating one example of a hardware configuration of the communication device according to embodiment 1. In FIG. 7, like part as the part illustrated in FIG. 6 is given the same numeral and description is omitted. The communication device 600 illustrated in FIG. 6 includes a digital circuit 710, an analog circuit 720, and the antennas 651 and 652 as illustrated in FIG. 7, for example.

The coding unit 610, the modulating unit 620, and the precoder 630 illustrated in FIG. 6 may be implemented by the digital circuit 710, for example. As the digital circuit 710, various kinds of processors such as a digital signal processor (DSP) and a field programmable gate array (FPGA) may be used.

The RF units 641 and 642 illustrated in FIG. 6 may be implemented by the analog circuit 720, for example. The analog circuit 720 includes a digital/analog converter (DAC), a mixer, an amplifier, and so forth, for example.

As above, according to the communication device 110 in accordance with embodiment 1, eigenvalues may be calculated based on the second equation about the eigenvalues of the solution matrix of the first equation based on the channel matrix H. Furthermore, eigenvectors of the solution matrix may be calculated based on the calculated eigenvalues and the expanded VFDM weight matrix W may be generated based on the calculated eigenvalues and eigenvectors. This may reduce the amount of operation of the expanded VFDM weight matrix W used for the expanded VFDM using plural transmitting antennas.

### Embodiment 2

Regarding embodiment 2, a different part from embodiment 1 will be described. In embodiment 2, a configuration will be described in which, after eigenvalues and eigenvectors of the solution matrix of the above-described expression (4) are obtained, the expanded VFDM weight matrix W is generated without obtainment of the solution matrix of the above-described expression (4).

For example, in embodiment 1, after the eigenvalues λ are obtained, the solution matrix of the above-described expression (4) is obtained by using the obtained eigenvalues λ and thereafter the expanded VFDM weight matrix W is generated. However, it is also possible to obtain the expanded VFDM weight matrix W from eigenvalues λₙ and eigenvectors vₙ corresponding to the eigenvalues λₙ based on the above-described expression (39) without obtaining the solution matrix of the above-described expression (4). This makes operation of powers of a matrix unnecessary, which may further reduce the amount of operation.

Next, an actual calculation example in embodiment 2 will be described. For example, when the above-described expression (39) is used, the expanded VFDM weight matrix W is obtained as represented by the following expression (59). This seems to be a form different from the above-described expression (58). However, when HW based on the expanded VFDM weight matrix W of the following expression (59) is calculated, the calculation result is 0.

$$\begin{matrix}[ Expression 59 ] & \\ W = ( \begin{matrix}{λ}_{1}^{0} {v}_{1} & {λ}_{2}^{0} {v}_{2} \\ {λ}_{1}^{1} {v}_{1} & {λ}_{2}^{1} {v}_{2} \\ {λ}_{1}^{2} {v}_{1} & {λ}_{2}^{2} {v}_{2}\end{matrix} ) = ( \begin{matrix}- 0.952226 & - 0.661458 \\ 0.305393 & 0.749982 \\ 0.727436 & 3.463441 \\ - 0.233300 & - 3.926956 \\ - 0.555712 & - 18.134815 \\ 0.718225 & 20.561807\end{matrix} ) & ( 59 )\end{matrix}$$

(Weight Matrix Generating Unit of Communication Device According to Embodiment 2)

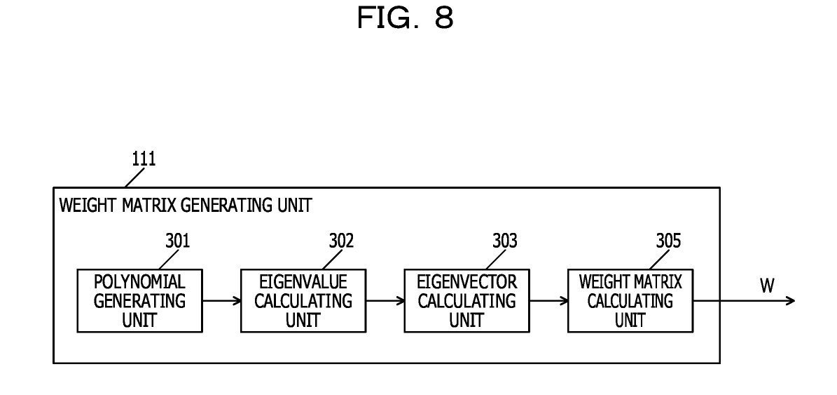

FIG. 8 is a diagram illustrating one example of a weight matrix generating unit of a communication device according to embodiment 2. In FIG. 8, like part as the part illustrated in FIG. 3 is given the same symbol and description is omitted. As illustrated in FIG. 8, a weight matrix generating unit 111 of a communication device 110 according to embodiment 2 has a configuration obtained by omitting the solution matrix calculating unit 304 in the configuration illustrated in FIG. 3.

In the example illustrated in FIG. 8, the eigenvector calculating unit 303 notifies the weight matrix calculating unit 305 of ML eigenvalues λ notified from the eigenvalue calculating unit 302 and eigenvectors v calculated about each of the ML eigenvalues λ. The weight matrix calculating unit 305 generates the expanded VFDM weight matrix W based on the eigenvalues λ and the eigenvectors v notified from the eigenvector calculating unit 303 and the above-described expression (39).

Due to this, without obtainment of the solution matrix of the above-described expression (4), the expanded VFDM weight matrix W substantially orthogonal to the channel matrix H may be generated and output to the multiplying unit 112. This may reduce the amount of operation for generating the expanded VFDM weight matrix W.

(Weight Matrix Operation Processing by Communication Device According to Embodiment 2)

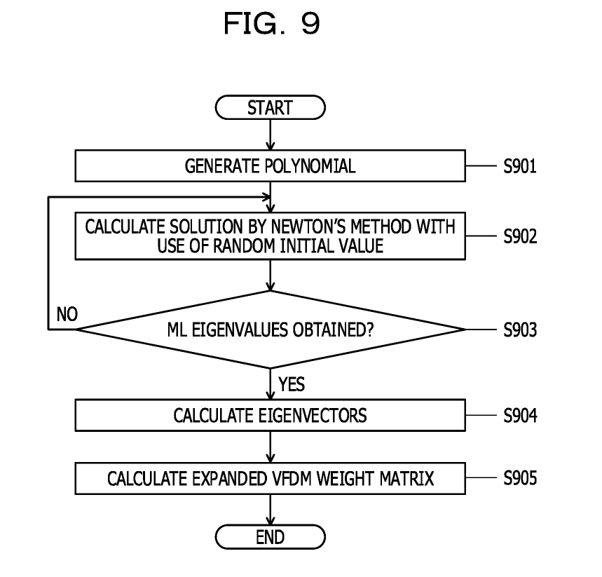

FIG. 9 is a flowchart illustrating one example of weight matrix operation processing by the communication device according to embodiment 2. The communication device 110 according to embodiment 2, for example, carries out each step depicted in FIG. 9 as operation processing of the expanded VFDM weight matrix W.

Steps S901 to S904 depicted in FIG. 9 are similar to the steps S501 to S504 depicted in FIG. 5. Subsequently to the step S904, the communication device 110 calculates the expanded VFDM weight matrix W based on ML eigenvalues calculated by the steps S902 and S903 and ML eigenvectors calculated by the step S904 (step S905). Then, the communication device 110 ends the series of weight matrix operation processing. The generation of the expanded VFDM weight matrix W by the step S905 may be carried out based on the above-described expression (39), for example. By the respective steps depicted in FIG. 9, the communication device 110 may generate the expanded VFDM weight matrix W substantially orthogonal to the channel matrix H without obtaining the solution matrix of the above-described expression (4).

As above, according to the communication device 110 in accordance with embodiment 2, the expanded VFDM weight matrix W may be generated based on the calculated eigenvalues λ and eigenvectors v, for example, based on the above-described expression (39) without calculation of the solution matrix of the first equation about Z. This makes it possible to generate the expanded VFDM weight matrix W without performing operation of powers of a matrix, which may reduce the amount of operation for generating the expanded VFDM weight matrix W.

### Embodiment 3

Regarding embodiment 3, a different part from embodiment 2 will be described. In embodiment 3, the expanded VFDM weight matrix W generated by the method of embodiment 1 or 2 is not used as a weighting matrix as it is, and a matrix orthogonalized through QR decomposition of the expanded VFDM weight matrix W is used as the weighting matrix.

(Weight Matrix Generating Unit of Communication Device According to Embodiment 3)

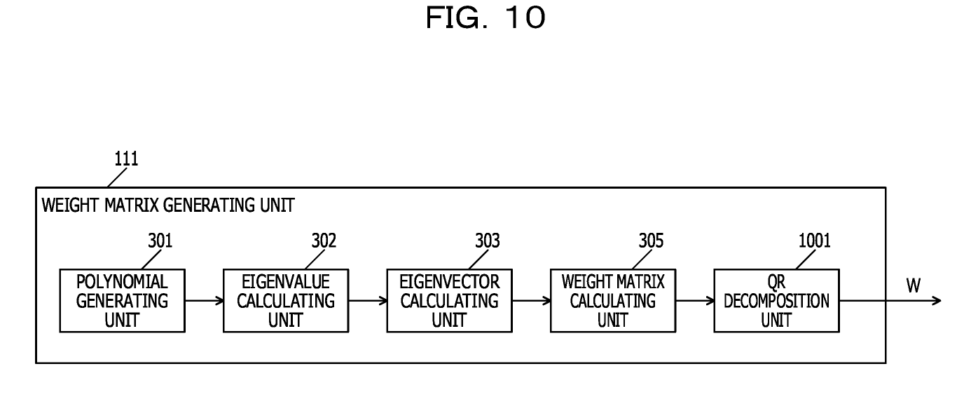

FIG. 10 is a diagram illustrating one example of a weight matrix generating unit of a communication device according to embodiment 3. In FIG. 10, like part as the part illustrated in FIG. 8 is given the same symbol and description is omitted. As illustrated in FIG. 10, a weight matrix generating unit 111 of a communication device 110 according to embodiment 3 includes a QR decomposition unit 1001 in addition to the configuration illustrated in FIG. 8.

In the example illustrated in FIG. 10, the weight matrix calculating unit 305 outputs the calculated expanded VFDM weight matrix W to the QR decomposition unit 1001. The QR decomposition unit 1001 orthogonalizes the expanded VFDM weight matrix W by carrying out QR decomposition of the expanded VFDM weight matrix W output from the weight matrix calculating unit 305 and acquiring a matrix Q (orthogonal matrix) obtained by the QR decomposition as the expanded VFDM weight matrix W after the orthogonalization. Then, the QR decomposition unit 1001 outputs the orthogonalized expanded VFDM weight matrix W to the multiplying unit 112 (see FIG. 1).

In the configuration illustrated in FIG. 10, the amount of operation of the QR decomposition by the QR decomposition unit 1001 is on the order of the square of the number of columns in the matrix as the target of the QR decomposition. For this reason, if the expanded VFDM weight matrix W output from the weight matrix calculating unit 305 may be divided into groups of substantially orthogonal weights in advance, the sum of the amounts of operation of the QR decomposition carried out for the respective groups is smaller than the amount of operation when the QR decomposition is carried out for the whole matrix. For example, the amount of operation becomes half if the expanded VFDM weight matrix W output from the weight matrix calculating unit 305 may be divided into groups each including half.

The weight matrix calculating unit 305 according to embodiment 3 generates the expanded VFDM weight matrix W by using the above-described expression (39) as described in embodiment 2. In this case, the eigenvalue and the column of the expanded VFDM weight matrix W correspond to each other in a one-to-one relationship as represented in the above-described expression (39). For example, the eigenvalue λ₁ corresponds to the first column of the expanded VFDM weight matrix W and the eigenvalue λ₂ corresponds to the second column of the expanded VFDM weight matrix W.

Therefore, the QR decomposition unit 1001 divides the respective columns of the expanded VFDM weight matrix W output from the weight matrix calculating unit 305 into a group in which the absolute value of the eigenvalue is larger than 1 and a group in which the absolute value is smaller than 1. Then, the QR decomposition unit 1001 carries out orthogonalization by QR decomposition of the expanded VFDM weight matrix W output from the weight matrix calculating unit 305 on each group basis.

(Transmission Weights when Grouping is Carried Out by Communication Device According to Embodiment 3)

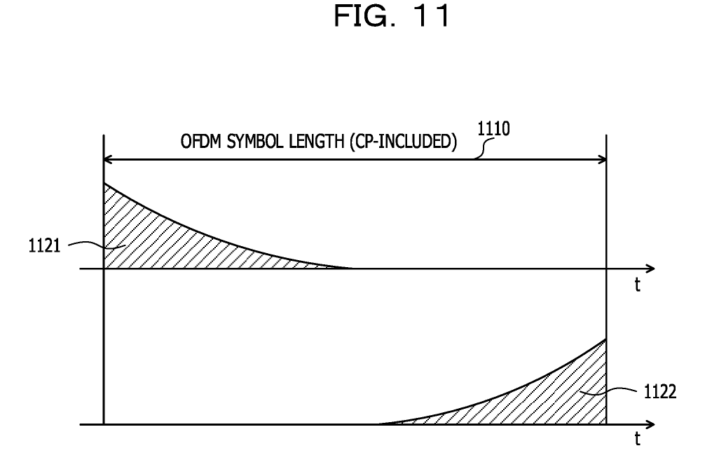

FIG. 11 is a diagram illustrating one example of transmission weights when grouping is carried out by the communication device according to embodiment 3. In FIG. 11, the abscissa axis indicates the time (t) and the vertical direction indicates the power value of the weight on the transmission signal. OFDM symbol length 1110 is symbol length (CP-included) including a cyclic prefix (CP) of an OFDM symbol transmitted by the communication device 110.

The time direction indicated in FIG. 11 corresponds to the vertical direction of the matrix of the above-described expression (39). For example, the first column of the matrix of the above-described expression (39) is λ₁⁰v₁, λ₁¹v₁, λ₁²v₁, . . . . Therefore, if the absolute value of the eigenvalue λ is smaller than 1, the transmission weight exponentially decreases with respect to the time direction. If the absolute value of the eigenvalue λ is larger than 1, the transmission weight exponentially increases with respect to the time direction. Although the description is made about the first column of the matrix of the above-described expression (39), like applies also to the second and subsequent columns of the matrix of the above-described expression (39).

A transmission weight 1121 represents time change of the transmission weight in the group corresponding to the eigenvalue λ whose absolute value is smaller than 1 among the respective columns of the matrix of the above-described expression (39). A transmission weight 1122 represents time change of the transmission weight in the group corresponding to the eigenvalue λ whose absolute value is larger than 1 among the respective columns of the matrix of the above-described expression (39).

Therefore, in many cases, the transmission weight in which the absolute value of the eigenvalue is larger than 1 and the transmission weight in which the absolute value of the eigenvalue is smaller than 1 are substantially orthogonal to each other. Therefore, the respective columns of the matrix of the above-described expression (39) are grouped depending on whether the absolute value of the corresponding eigenvalue is larger or smaller than 1. In this case, the groups are substantially orthogonal to each other. Thus, the whole matrix may be orthogonalized if QR decomposition is carried out on each group basis to carry out orthogonalization in each group. Furthermore, the amount of operation of the QR decomposition is on the order of the square of the number of columns as described above. Thus, by carrying out the QR decomposition on each group basis, the amount of operation may be reduced compared with the case of carrying out QR decomposition on the whole of the expanded VFDM weight matrix W output from the weight matrix calculating unit 305.

Next, an actual calculation example in embodiment 3 will be described. Assuming that L=2 and M=2, four (=LM) eigenvalues are obtained. As small matrices in the channel matrix H, 4×4 complex number matrices represented as the following expression (60), the following expression (61), and the following expression (62) will be assumed.

$$\begin{matrix}[ Expression 60 ] & \\ {C}_{0} = ( \begin{matrix}1 & 0 \\ 0 & 1\end{matrix} ) & ( 60 ) \\ [ Expression 61 ] & \\ {C}_{1} = ( \begin{matrix}( 0.89637 - 1.15760 i ) & ( 1.43246 + 1.86863 i ) \\ ( - 0.17041 - 0.25685 i ) & ( 1.67047 - 0.92662 i )\end{matrix} ) & ( 61 ) \\ [ Expression 62 ] & \\ {C}_{2} = ( \begin{matrix}( - 0.82900 - 1.24944 i ) & ( - 0.26728 + 0.98778 i ) \\ ( - 1.30378 - 0.41617 i ) & ( 0.11367 + 0.59681 i )\end{matrix} ) & ( 62 )\end{matrix}$$

(Calculation Result of Eigenvalues by Communication Device According to Embodiment 3)

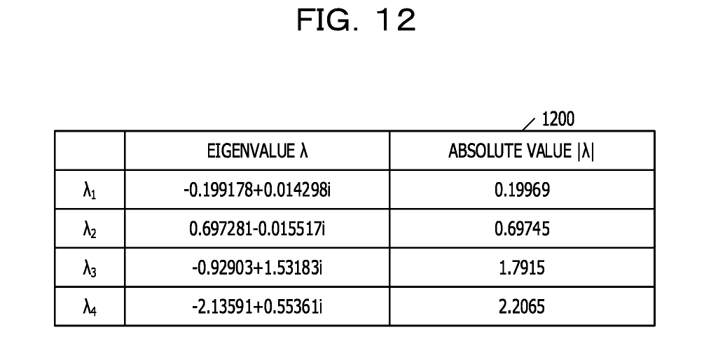

FIG. 12 is a diagram illustrating one example of a calculation result of eigenvalues by the communication device according to embodiment 3. An eigenvalue calculation result 1200 represented in FIG. 12 indicates four eigenvalues λ (λ₁ to λ₄) and the absolute values |λ| of the four eigenvalues λ that are calculated by the communication device 110 based on the example of the above-described expression (60), the above-described expression (61), and the above-described expression (62).

In the example represented in FIG. 12, λ₁ and λ₂ have the absolute value smaller than 1 and λ₃ and λ₄ have the absolute value larger than 1. For this reason, the QR decomposition unit 1001 generates a weight matrix W₁ by using λ₁ and λ₂ and the above-described expression (39) as represented in the following expression (63), and generates a weight matrix W₂ by using λ₃ and λ₄ and the above-described expression (39) as represented in the following expression (64).

$$\begin{matrix}[ Expression 63 ] & \\ {W}_{1} = ( \begin{matrix}{λ}_{1}^{0} {v}_{1} & {λ}_{2}^{0} {v}_{2} \\ {λ}_{1}^{1} {v}_{1} & {λ}_{2}^{1} {v}_{2} \\ ⋮ & ⋮ \\ {λ}_{1}^{N + L - 1} {v}_{1} & {λ}_{2}^{N + L - 1} {v}_{2}\end{matrix} ) & ( 63 ) \\ [ Expression 64 ] & \\ {W}_{2} = ( \begin{matrix}{λ}_{3}^{- N - L + 1} {v}_{3} & {λ}_{4}^{- N - L + 1} {v}_{4} \\ {λ}_{3}^{- N - L + 2} {v}_{3} & {λ}_{4}^{- N - L + 2} {v}_{4} \\ ⋮ & ⋮ \\ {λ}_{3}^{0} {v}_{3} & {λ}_{4}^{0} {v}_{4}\end{matrix} ) & ( 64 )\end{matrix}$$

Note that the weight matrix W₂ is made through division of the respective columns by λ₃^{-N-L+1} and λ₄^{-N-L+1} for amplitude adjustment. The magnitude of N corresponds to the size of a fast Fourier transform (FFT) used in the OFDM and a large value equal to or larger than, for example, 128 is frequently used. The amplitude of the weight depends on the power of λ. However, for example, in the case of λ₂, the absolute value is approximately 0.69 and therefore 0.69⁵⁰=approximately 0.0000000087 is obtained. Thus, the values in the lower half of the weight matrix W₁, in which powers larger than 50 are included, become almost zero.

Similarly, the values in the upper half of W₂ become almost 0. Thus, at this timing, the state in which the weights included in each of W₁ and W₂ are substantially orthogonal to each other is obtained. For this reason, by individually orthogonalizing W₁ and W₂, orthogonal weights may be generated as a whole. Then, a matrix made by lining up obtained W₁ and W₂ in the horizontal direction is output to the multiplying unit 112 as the expanded VFDM weight matrix W. This may reduce the amount of operation for orthogonalizing the expanded VFDM weight matrix W.

As above, the communication device 110 according to embodiment 3 orthogonalizes, in the respective elements (columns) of a matrix generated based on the right side of the above-described expression (39), each of an element group in which the absolute value of the eigenvalue included in the element is smaller than 1 and an element group in which the absolute value of the eigenvalue included in the element is larger than 1. Then, the communication device 110 generates the expanded VFDM weight matrix W by lining up the respective orthogonalized element groups. This may reduce the amount of operation for generating the orthogonalized expanded VFDM weight matrix W.

As for an element group in which the absolute value of the eigenvalue λ is 1, the element group may be orthogonalized with the element group in which the absolute value of the eigenvalue λ is smaller than 1, or may be orthogonalized with the element group in which the absolute value of the eigenvalue λ is larger than 1, or may not be orthogonalized.

As described above, according to the communication device, the communication method, and the communication system, the amount of operation of the weight matrix used for radio transmission may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and the processor configured to:
specify eigenvalues of a solution matrix of a first equation, the first equation being base on a channel matrix representing a channel state between a first communication device and the communication device, the first communication device being a communication device different from a communication device of a transmission destination, the eigenvalues being specified by using a second equation about the eigenvalues;
specify eigenvectors of the solution matrix based on the specified eigenvalues;
generate weight information corresponding to a plurality of antennas based on the eigenvalues and the eigenvectors; and
transmit a signal weighted based on the weight information to the communication device of the transmission destination by the plurality of antennas.

2. The communication device according to claim 1, wherein
the processor is configured to:
generate the weight information based on the eigenvalues and the eigenvectors that are calculated without calculating the solution matrix.

3. The communication device according to claim 2, wherein
the weight information is a weight matrix based on the eigenvalues and the eigenvectors; and wherein
the processor is configured to:
orthogonalize, in each of a plurality of elements included the weight matrix, a first element group in which an absolute value of the eigenvalue included in the element is smaller than 1 and a second element group in which the absolute value of the eigenvalue included in the element is larger than 1; and
generate the weight matrix by lining up the first element group and second element groups.

4. The communication device according to claim 1, wherein
the eigenvalues is specified by using iterative operation.

5. A communication method executed by a communication device, the communication method comprising:
specifying eigenvalues of a solution matrix of a first equation, the first equation being base on a channel matrix representing a channel state between a first communication device and the communication device, the first communication device being a communication device different from a communication device of a transmission destination, the eigenvalues being specified by using a second equation about the eigenvalues;
specifying eigenvectors of the solution matrix based on the specified eigenvalues;
generating weight information corresponding to a plurality of antennas based on the eigenvalues and the eigenvectors; and
transmitting a signal weighted based on the weight information to the communication device of the transmission destination by the plurality of antennas.

6. A communication system comprising:
a first communication device; and
a second communication device; wherein
the first communication device including:
a first memory; and
a first processor coupled to the memory and the first processor configured to:
specify eigenvalues of a solution matrix of a first equation, the first equation being base on a channel matrix representing a channel state between the first communication device and a communication device different from the second communication device, the eigenvalues being specified by using a second equation about the eigenvalues;
specify eigenvectors of the solution matrix based on the specified eigenvalues;
generate weight information corresponding to a plurality of antennas based on the eigenvalues and the eigenvectors; and
transmit a signal weighted based on the weight information to the communication device of the transmission destination by the plurality of antennas; and wherein
the second communication device including:
a receiver that receives the signal transmitted by the first communication device.
